(19) United States
(12) Patent Application Publication
(10) Pub. No.: US 2009/0164208 A1
(43) Pub. Date: Jun. 25, 2009

(54) METHOD AND APPARATUS FOR ALIGNING PARALLEL SPOKEN LANGUAGE CORPORA

(76) Inventors: Ren DENGJUN, Beijing (CN); Wu HUA, Beijing (CN); Wang HAIFENG, Beijing (CN)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(21) Appl. No.: 12/335,733

(22) Filed: Dec. 16, 2008

(30) Foreign Application Priority Data
Dec. 20, 2007 (CN) 200710199195.7

(51) Int. Cl. G06F 17/27; G10L 21/00

(52) U.S. Cl. 704/9; 704/277; 704/E21.001

(57) ABSTRACT

The method for aligning parallel spoken language corpora comprises obtaining a statistics method and dictionaries-based word alignment set from the parallel spoken language corpora, aligning chunks of the parallel spoken language corpora by using the statistics method and dictionaries-based word alignment set, to obtain a chunk alignment set, and aligning words in aligned chunks of the parallel spoken language corpora to obtain a chunk alignment-based word alignment set. Chunk alignment set and word alignment set are obtained by aligning chunks in parallel spoken language corpora in a corpus repository using a statistics method and dictionaries-based high precision word alignment set obtained from the parallel spoken language corpora and further aligning words in the chunks, and by using them in the speech-to-speech machine translation, the ambiguities of spoken language word alignment can be decreased by using the integrality of chunks.

### CROSS-REFERENCE TO RELATED APPLICATIONS

This application is based upon and claims the benefit of priority from prior Chinese Patent Application No. 200710199195.7, filed Dec. 20, 2007, the entire contents of which are incorporated herein by reference.

### BACKGROUND OF THE INVENTION

1. Field of the Invention

The present invention relates to information processing technology, and particularly to chunk alignment and word alignment of parallel spoken language corpora.

2. Description of the Related Art

The machine translation technology is mainly categorized as rule-based machine translation and corpus-based machine translation.

In the corpus-based machine translation, the main translation resources come from a corpus repository. That is, in the corpus-based machine translation, parallel bilingual corpora in the corpus repository are training bases of machine translation. The process of the corpus-based machine translation is that: first the word processes such as word aligning, syntax analysis are performed on the parallel bilingual corpora in the corpus repository, to form aligned, syntax analyzed sentence couples; then a translation engine regards such sentence couples as framework structures, and when a user inputs a sentence to be translated, the translation engine matches the input sentence with these framework structures, if the matching is successful, then the sentence is translated according to the matched framework structure, to obtain the translation in target language of the input sentence.

It can be seen that the alignment of the parallel bilingual corpora in the corpus repository is the precondition and plays a crucial role in the corpus-based machine translation, because the quality of translations obtained by the corpus-based machine translation will largely depend on the alignment quality of corpora.

The aligning of corpora includes paragraph level aligning, sentence level aligning, chunk structure level aligning, word level aligning and etc.

The word aligning means finding the correspondence between source language corpora and target language corpora at the word level. That is, the words having semantic similarity to those in source language corpora are found from target language corpora, to establish a correspondence between the source language sentences and target language sentences in the translating unit, i.e. word.

There exist many methods for word aligning currently. However, most of current alignment methods work well on well-formed written language, not on spoken language in speech-to-speech machine translation, because they didn't take the characteristics of spoken language into account. In practice, there are some differences between spoken language and well-formed written language.

For spoken language, the structures of sentences are very flexible, the language stream is not as fluent as that of written language, and disfluencies such as repetition, hesitation, ellipsis and etc. often occur, which will not occur in well-formed written language.

Thus, because of the differences between spoken language and well-formed written language, in the speech-to-speech machine translation, even if a method capable of aligning well-formed written language excellently is used to align spoken language, the effect will be not satisfied.

Therefore, there is a need for a method for effectively aligning spoken language, which adapts to the characteristics of spoken language.

### BRIEF SUMMARY OF THE INVENTION

According to embodiments of the present invention, there is provided a method and apparatus for aligning parallel spoken language corpora as well as a speech-to-speech machine translation method and system employing such method and apparatus for aligning parallel spoken language corpora respectively, so as to obtain chunk alignment set and word alignment set by aligning chunks in parallel spoken language corpora in a corpus repository using a statistics method and dictionaries-based high precision word alignment set obtained from the parallel spoken language corpora and further aligning words in the chunks, and use them in the speech-to-speech machine translation, thereby decreasing the ambiguities of spoken language word alignment by using the integrality of chunks.

According to one aspect of the present invention, there is provided a method for aligning parallel spoken language corpora, comprising: obtaining a statistics method and dictionaries-based word alignment set from the parallel spoken language corpora; aligning chunks of the parallel spoken language corpora by using the statistics method and dictionaries-based word alignment set, to obtain a chunk alignment set; and aligning words in aligned chunks of the parallel spoken language corpora to obtain a chunk alignment-based word alignment set.

According to another aspect of the present invention, there is provided a speech-to-speech machine translation method, which performs speech-to-speech machine translation based on a spoken language corpus repository containing parallel spoken language corpora, the method comprises: obtaining a chunk alignment set and a word alignment set from the parallel spoken language corpora in the spoken language corpus repository by using the method for aligning parallel spoken language corpora described above; and performing source-to-target language speech-to-speech machine translation on input spoken language sentences to be translated by using the chunk alignment set and word alignment set.

According to a further aspect of the present invention, there is provided an apparatus for aligning parallel spoken language corpora, comprising: a statistics method and dictionaries-based word alignment set getting unit for obtaining a statistics method and dictionaries-based word alignment set from the parallel spoken language corpora; a chunk aligning unit for aligning chunks of the parallel spoken language corpora by using the statistics method and dictionaries-based word alignment set, to obtain a chunk alignment set; and a word-in-chunk aligning unit for aligning words in aligned chunks of the parallel spoken language corpora to obtain a chunk alignment-based word alignment set.

According to still another aspect of the present invention, there is provided a speech-to-speech machine translation system, which performs speech-to-speech translation based on a spoken language corpus repository containing parallel spoken language corpora, the system comprises: the apparatus for aligning parallel spoken language corpora described above for obtaining a chunk alignment set and a word alignment set from the parallel spoken language corpora in the spoken language corpus repository; and a speech-to-speech translation module for performing source-to-target language speech-to-speech translation on input spoken language sentences to be translated by using the word alignment set.

### BRIEF DESCRIPTION OF THE SEVERAL VIEWS OF THE DRAWING

FIG. 1 is a flowchart of a method for aligning parallel spoken language corpora according to an embodiment of the present invention;

FIG. 2 is a detailed flowchart of the step of preprocessing parallel spoken language corpora in the method of FIG. 1;

FIG. 3 is a detailed flowchart of the step of obtaining a statistics method and dictionaries-based high precision word alignment set in the method of FIG. 1;

FIG. 4 is a detailed flowchart of the step of aligning chunks in the parallel spoken language corpora by using the statistics method and dictionaries-based high precision word alignment set in the method of FIG. 1;

FIG. 5 is a detailed flowchart of the step of aligning words in aligned chunks of the parallel spoken language corpora and correcting word alignment in the method of FIG. 1;

FIG. 6 is a flowchart of a speech-to-speech machine translation method according to an embodiment of the present invention;

FIG. 7 is a block diagram of an apparatus for aligning parallel spoken language corpora according to an embodiment of the present invention; and

FIG. 8 is a block diagram of a speech-to-speech machine translation system according to an embodiment of the present invention.

### DETAILED DESCRIPTION OF THE INVENTION

Next, a detailed description of each preferred embodiment of the present invention will be given with reference to the drawings. First, the method for aligning parallel spoken language corpora of the present invention will be described.

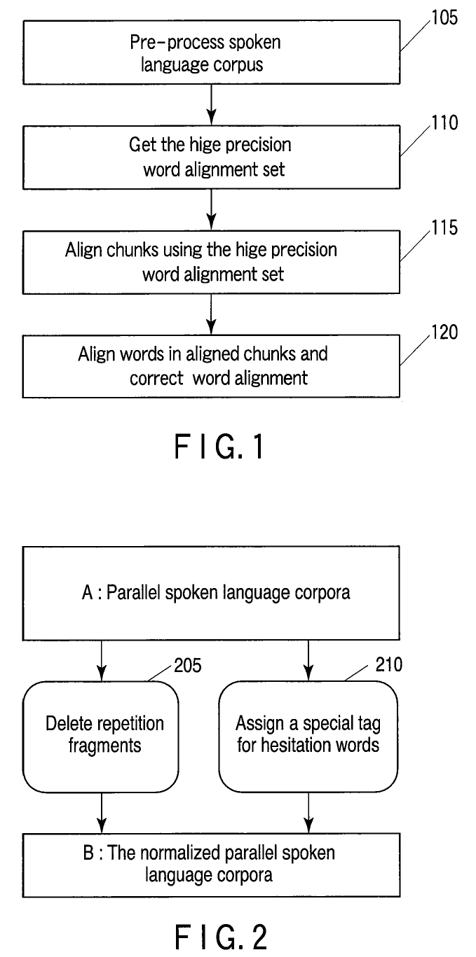

FIG. 1 is a flowchart of a method for aligning parallel spoken language corpora in a spoken language corpus repository according to an embodiment of the present invention.

As shown in FIG. 1, first, at step 105, the parallel spoken language corpora are pre-processed with respect to the characteristics of spoken language to obtain normalized parallel spoken language corpora.

FIG. 2 shows a detailed flowchart of step 105 of preprocessing the parallel spoken language corpora in the spoken language corpus repository, wherein A indicates original parallel spoken language corpora in the spoken language corpus repository.

As shown in FIG. 2, first, at step 205, repetition fragments are deleted from the parallel spoken language corpora A of the spoken language corpus repository. As described above, repetition is an usual phenomenon existing in spoken language and is one of the characteristics of spoken language. The repetition fragments in spoken language corpora directly result in disfluency of sentences, thus the quality of alignment result obtained based on such sentences must be impacted, which will finally impact the accuracy of translation result. Therefore in the embodiment, before chunk aligning and word aligning, such preprocessing for deleting repetition fragments in the spoken language corpora first is performed to ensure the accuracy of chunk alignment and word alignment of the parallel spoken language corpora.

Next at step 210, in the parallel spoken language corpora A of the spoken language corpus repository, a special tag is assigned to hesitating words. The step is performed based on a preset list of hesitating words.

As described above, hesitation also is an usual phenomenon existing in spoken language and also will result in disfluency of spoken sentences. And according to the characteristics of spoken language, hesitating words usually have little practical meanings or the meanings of which are not crucial for the meanings expressed by the spoken sentences containing the hesitating words.

Therefore, at this step, based on a preset list in which most hesitating words are listed, such hesitating words are found in the parallel spoken language corpora A of the spoken language corpus repository and are assigned a special tag so that they will be specially handled during word aligning thereafter.

As shown in FIG. 2, through the pre-processes of the steps 205 and 210 performed on the parallel spoken language corpora A, normalized parallel spoken language corpora indicated by B are obtained.

The above is a detailed flow of the process of pre-processing the parallel spoken language corpora in the spoken language corpus repository at step 105 of FIG. 1. It should be noted that, although steps 205 and 210 are shown to perform in parallel in order to indicate the independency therebetween in FIG. 2, the present invention is not limited to this, and in other embodiments, the two steps can be performed sequentially, and their performing sequence can be any, which will not impact the preprocessing result.

Returning to FIG. 1, at step 110, based on the preprocessed parallel spoken language corpora, a statistics method and dictionaries-based high precision word alignment set (statistics method and dictionaries-based word alignment set) is obtained.

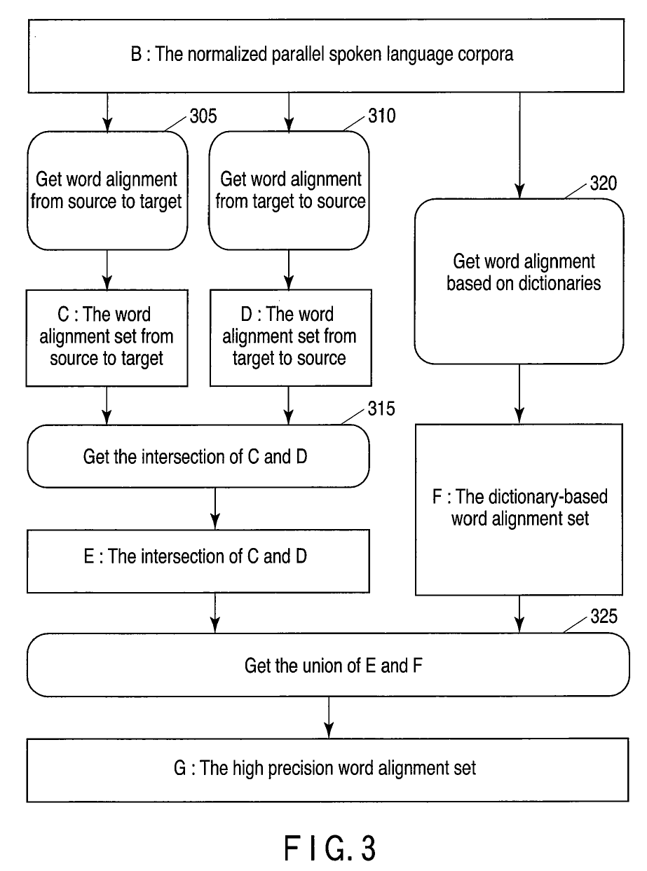

FIG. 3 shows a detailed flowchart of the above step 110 of obtaining a statistics method and dictionaries-based high precision word alignment set based on the preprocessed parallel spoken language corpora.

As shown in FIG. 3, first, at step 305, a statistics word alignment set C from source to target is obtained based on the normalized parallel spoken language corpora B obtained after preprocessing. That is, at this step, by using a statistics method, a corpus-based statistics word alignment set C from source to target is obtained based on source spoken language sentences and corresponding target spoken language sentences in the parallel spoken language corpora B. It should be noted that it is a common technique in the art to obtain a word alignment set from parallel spoken language corpora by using a statistics method, and there is no specific limit on the implementation of this step in the invention.

At step 310, based on the normalized parallel spoken language corpora B, a statistics word alignment set D from target to source is obtained. That is, at this step, by using a statistics method, a corpus-based statistics word alignment set D from target to source is obtained based on target spoken language sentences and corresponding source spoken language sentences in the parallel spoken language corpora B. It should be noted that it is a common technique in the art to obtain a word alignment set from parallel spoken language corpora by using a statistics method, and there is no specific limit on the implementation of this step in the invention.

At step 315, the intersection E of the statistics word alignment set C from source to target and the statistics word alignment set D from target to source is obtained. The object of the step is to condense the scope of the statistics word alignment set C from source to target and that of the statistics word alignment set D from target to source obtained based on the corpora, to obtain a refined statistics word alignment set E based only on the parallel spoken language corpora.

At step 320, with respect to the normalized parallel spoken language corpora B, a source-target language dictionary and a target-source language dictionary are searched for the words in the normalized parallel spoken language corpora B, to obtain a dictionary-based word alignment set F, wherein each alignment item in the dictionary-based word alignment set F is an entry in the source-target language dictionary and is also an entry in the target-source language dictionary.

Specifically, at this step, with respect to the source language sentences in the normalized parallel spoken language corpora B, the source-target language dictionary is searched for the words in the source language sentences to obtain a dictionary-based word alignment set from source to target corresponding to the them; with respect to the target language sentences in the normalized parallel spoken language corpora B, the target-source language dictionary is searched for the words in the target language sentences to obtain a dictionary-based word alignment set from target to source corresponding to them; and the intersection of the dictionary-based word alignment set from source to target and the dictionary-based word alignment set from target to source is derived to obtain the final dictionary-based word alignment set F.

Next at step 325, the union of the above corpus-based statistics word alignment set E and the above dictionary-based word alignment set F is obtained as the statistics method and dictionaries-based high precision word alignment set G. That is, at this step, the word alignment set E obtained based only on the spoken language corpora is extended by using the word alignment set F obtained based on the source-target language dictionary and the target-source language dictionary, to obtained a more complete and widely adaptive word alignment set as the statistics method and dictionaries-based high precision word alignment set G.

As shown in FIG. 3, through the processes of the above steps 305-325 performed on the normalized parallel spoken language corpora B, statistics method and dictionaries-based high precision word alignment set indicated by G is obtained.

The above is a detailed flow of the process of obtaining a statistics method and dictionaries-based high precision word alignment set based on the preprocessed parallel spoken language corpora at step 110 of FIG. 1. It should be noted that the performing sequence of the steps shown in FIG. 3 is only an exemplary. In other embodiments, as long as such a statistics method and dictionaries-based high precision word alignment set can be obtained, the performing sequence of steps 305-325 can be any, and there is no specific limit on this in the invention.

Returning to FIG. 1, at step 115, chunks in the preprocessed parallel spoken language corpora are aligned by using the statistics method and dictionaries-based high precision word alignment set obtained at step 110.

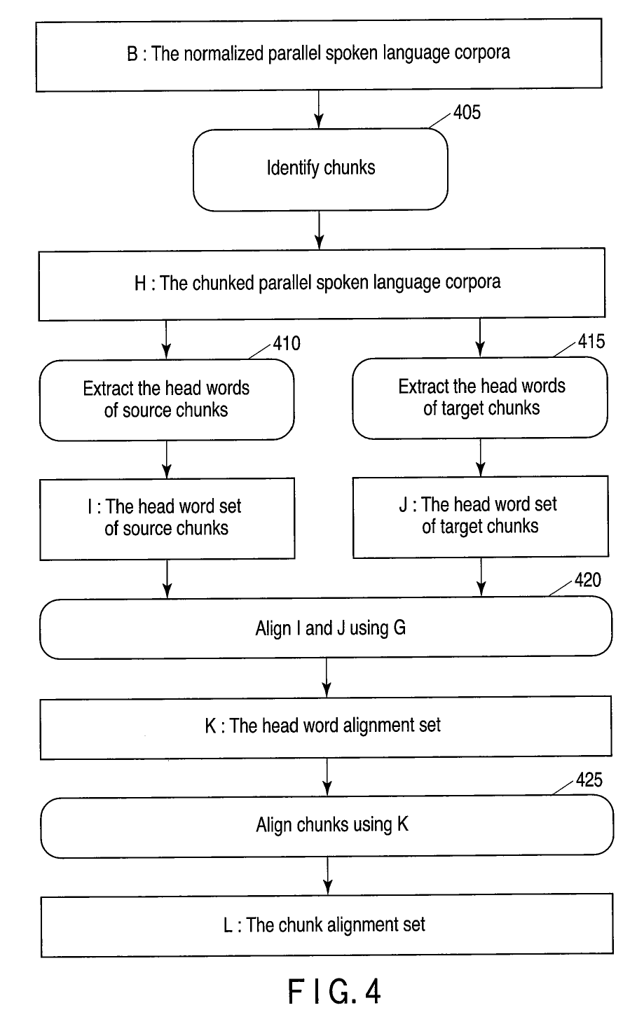

FIG. 4 shows a detailed flowchart of step 115 of aligning chunks in the preprocessed parallel spoken language corpora by using the statistics method and dictionaries-based high precision word alignment set.

As shown in FIG. 4, first at optional step 405, chunk analysis is performed on the normalized parallel spoken language corpora B obtained after preprocessing, to identify chunks therein, thus forming chunked parallel spoken language corpora H. Since the process of FIG. 4 is to align chunks in the parallel spoken language corpora B and chunk identification is the base of chunk aligning, the chunk analysis needs to be performed at the step on the parallel spoken language corpora B to be chunk aligned, to identify chunks therein before aligning chunks.

Next, at step 410, head words of identified source language chunks are extracted from the source language spoken sentences of the chunked parallel spoken language corpora H, to form a head word set I of source language chunks.

At step 415, head words of identified target language chunks are extracted from the target language spoken sentences of the chunked parallel spoken language corpora H, to form a head word set J of target language chunks.

At step 420, the head word set I of source language chunks and the head word set J of target language chunks are aligned by using the statistics method and dictionaries-based high precision word alignment set G obtained according to the process of FIG. 3, to obtain head word alignment set K. Specifically, at this step, if a word couple formed by a head word in the head word set I and a head word in the head word set J is in the statistics method and dictionaries-based high precision word alignment set G, then the word couple is added into the head word alignment set K as an alignment item. Thus each alignment item in the formed head word alignment set K is an alignment item in the statistics method and dictionaries-based high precision word alignment set G, that is, the head word alignment set K is a subset of the statistics method and dictionaries-based high precision word alignment set G.

Next at step 425, chunks in the above chunked parallel spoken language corpora H are aligned based on the head word alignment set K. Aligning chunks is to correspond the chunk parts of the source language spoken sentences in the parallel spoken language corpora H to those, which have identical meanings to the chunk parts of the source language spoken sentences, of the target language spoken sentences respectively.

Specifically, since if head words of chunks are in aligning state then the corresponding chunks can be aligned, at the step, for each pair of aligned head words in the head word alignment set K, the corresponding chunks containing the head words are aligned, and the aligned chunk couple is added into the chunk alignment set L.

Thus as shown in FIG. 4, through the processes of the above steps 405-425 performed on the parallel spoken language corpora B, chunk alignment set indicated by L is obtained.

The above is a detailed flow of the process of aligning chunks in the preprocessed parallel spoken language corpora by using the statistics method and dictionaries-based high precision word alignment set at step 115 of FIG. 1. It should be noted that in other embodiments, instead of including the above optional step 405, the chucked parallel spoken language corpora H may be obtained as the result of a separated process of chuck analyzing from the method for aligning parallel spoken language corpora of the present embodiment.

Returning to FIG. 1, at step 120, words in the aligned chunks of the parallel spoken language corpora are aligned and word alignment is corrected to obtain a final word alignment set.

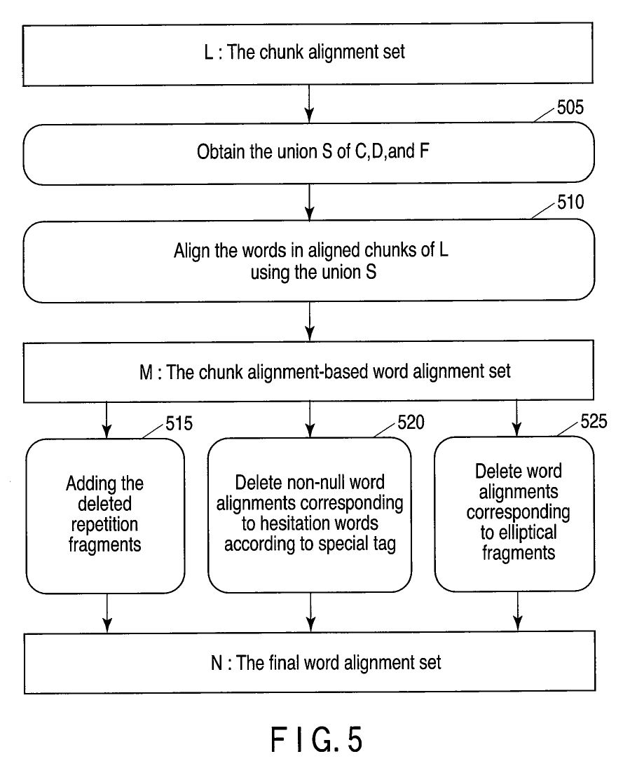

FIG. 5 shows a detailed flowchart of step 120 of aligning words in the aligned chunks of the parallel spoken language corpora and correcting word alignment.

As shown in FIG. 5, first at step 505, the union S of the above statistics word alignment set C from source to target, the statistics word alignment set D from target to source and the dictionary-based word alignment set F obtained in the process of FIG. 3, is obtained as a word alignment set covering a larger scope.

At step 510, by using the union S, words are aligned in the chunk alignment set L obtained according to the process of FIG. 4 to obtain a chunk alignment-based word alignment set M, wherein each alignment item in the word alignment set M is an alignment item in the union S.

Next, at step 515, the repetition fragments deleted at the preprocessing step 205 in FIG. 2 are restored in the word alignment set M. Specifically, at the step, with respect to the repetition fragments deleted at the preprocessing step 205 in FIG. 2, the word alignment items same as those of the fragments identical to the deleted repetition fragments, which remained in the parallel spoken language corpora B, are added into the word alignment set M as word alignment items corresponding to the deleted repetition fragments. That is, at the step, the word alignment items in the word alignment set M corresponding to the fragments repetitively appeared more than once in the parallel spoken language corpora are made the same, i.e., the alignments of identical fragments are made the same.

At step 520, according to the special tag assigned to the hesitating words at the preprocessing step 210 of FIG. 2, non-null word alignment items corresponding to such special tag are deleted from the word alignment set M. That is, at the step, the word alignment set M is made to exclude word alignment items corresponding to the hesitating words, thus the hesitating words are aligned with null.

At step 525, word alignment items corresponding to ellipsis fragments in the parallel spoken language corpora are deleted from the word alignment set M.

As shown in FIG. 5, through the processes of the above steps 505-525 performed on the chunk alignment set L, final word alignment set indicated by N is obtained. Thus the final word alignment set N can be directly applied to the speech-to-speech machine translation as a training base, combining with the chunk alignment set L.

The above is a detailed flow of the process of aligning words in the aligned chunks of the parallel spoken language corpora and correcting word alignment at step 120 of FIG. 1. It should be noted that, although the step of aligning words in the aligned chunks and the step of correcting word alignment are shown as a whole in FIG. 1 and FIG. 5, the present invention is not limited to this, and in other embodiments, the two steps can be implemented as separated steps from each other.

The above is the detailed description of the method for aligning parallel spoken language corpora of the present embodiment. In the present embodiment, first the parallel spoken language corpora in a spoken language corpus repository is preprocessed with respect to the characteristics of spoken language, then a high precision word alignment set is obtained from the preprocessed parallel spoken language corpora, and chunks in the preprocessed parallel spoken language corpora are aligned by using the high precision word alignment set, further words in the aligned chunks are aligned in turn and word alignment errors due to disfluencies of spoken language are corrected. Thereby, the ambiguities of spoken language word alignment can be decreased by using the integrality of chunks, and alignment errors due to the characteristics of spoken language can be cleaned by special processing with respect to the disfluencies such as ellipsis, repetition, hesitation and etc. in the spoken language corpora, thus alignment of spoken language can be achieved effectively to obtain highly refine chunk alignment set and word alignment set.

In addition, it should be noted that, the chunk alignment set and the word alignment set obtained by using the method for aligning parallel spoken language corpora of the embodiment can be applied not only in speech-to-speech machine translation, but also in many other language processing fields such as text machine translation, information retrieval and so on.

It should be noted that, although the method of FIG. 1 includes the preprocessing step 105 and correcting word alignment step of step 120, the present invention is not limited to this, and in other embodiments, these steps may be not included, in which case the objective of the present invention also can be achieved.

The speech-to-speech machine translation method of the present invention, which employs the method for aligning parallel spoken language corpora of the embodiment described in conjunction with FIGS. 1-5, will be described below in conjunction with the drawings.

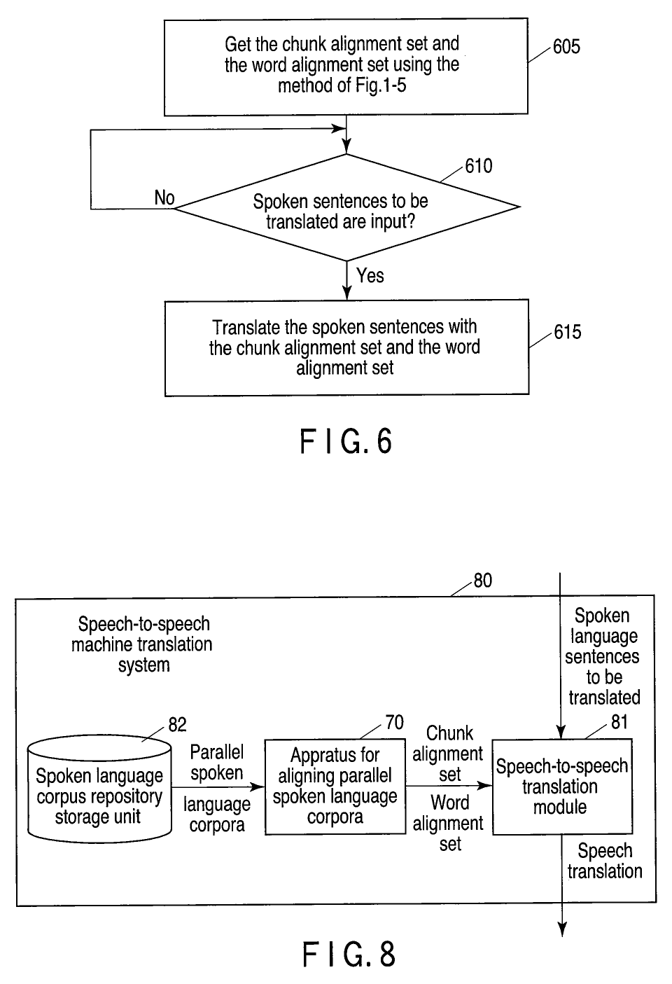

FIG. 6 is a flowchart of a speech-to-speech machine translation method according to an embodiment of the present invention. As shown in FIG. 6, first, at step 605, a chunk alignment set L and a word alignment set N are obtained from parallel spoken language corpora in a pre-constructed spoken language corpus repository by using the method for aligning parallel spoken language corpora of the embodiment described in conjunction with FIGS. 1-5.

At step 610, it is determined whether there is a spoken language sentence to be translated inputted by a user. And if there is a spoken language sentence to be translated inputted by a user, the method proceeds to step 615, otherwise continues to wait for user input.

At step 615, by using the chunk alignment set L and the word alignment set N obtained at step 605, speech-to-speech machine translation is performed on the input spoken language sentence to be translated to obtain target language speech corresponding to the input spoken language sentence.

The above is the detailed description of the speech-to-speech machine translation method of the present embodiment. The present embodiment can obtain highly accurate speech-to-speech machine translation result by applying the chunk alignment set and the word alignment set obtained by using the method for aligning parallel spoken language corpora of the above embodiment to the speech-to-speech machine translation.

In addition, it should be noted that in the present invention, there is no special limitation on the adopted spoken language corpus repository in the present invention. As long as the spoken language corpora contained therein are sufficiently universal and widely applicable and can be served as a training base of speech-to-speech machine translation fully, any spoken language corpus repository constructed by using a method presently known or future knowable can be adopted.

Under the same inventive concept, the present invention provides an apparatus for aligning parallel spoken language corpora. It will be described below in conjunction with the drawings.

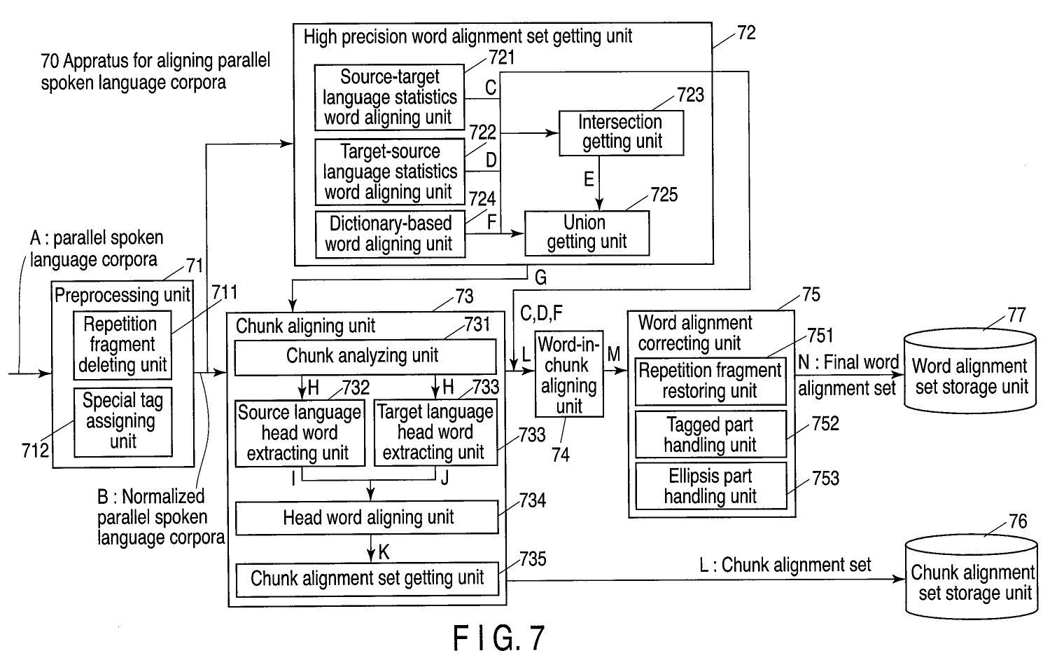

FIG. 7 is a block diagram of an apparatus for aligning parallel spoken language corpora according to an embodiment of the present invention. As shown in FIG. 7, the apparatus 70 for aligning parallel spoken language corpora of the present embodiment comprises high precision word alignment set getting unit (statistics method and dictionaries-based word alignment set getting unit) 72, chunk aligning unit 73, word-in-chunk aligning unit 74, chunk alignment set storage unit 76 and word alignment set storage unit 77.

The apparatus 70 for aligning parallel spoken language corpora of the present embodiment may further comprise preprocessing unit 71 for preprocessing the parallel spoken language corpora A in the spoken language corpus repository with respect to characteristics of spoken language, to obtain normalized parallel spoken language corpora B.

As shown in FIG. 7, the preprocessing unit 71 may further comprise repetition fragment deleting unit 711 for deleting repetition fragments in the parallel spoken language corpora A; and special tag assigning unit 712 for searching for hesitating words in the parallel spoken language corpora A according to a preset list of hesitating words, and assigning a special tag to them.

In addition, the high precision word alignment set getting unit 72 is configured to obtain a statistics method and dictionaries-based high precision word alignment set G from the preprocessed parallel spoken language corpora B in the spoken language corpus repository.

Specifically, as shown in FIG. 7, the high precision word alignment set getting unit 72 further comprises: source-target language statistics word aligning unit 721 for obtaining a corpus-based statistics word alignment set C from source to target by using a statistics method based on the parallel spoken language corpora B; target-source language statistics word aligning unit 722 for obtaining a corpus-based statistics word alignment set D from target to source by using a statistics method based on the parallel spoken language corpora B; intersection getting unit 723 for obtaining the intersection of the statistics word alignment set C from source to target and the statistics word alignment set D from target to source to obtain a corpus-based statistics word alignment set E; dictionary-based word aligning unit 724 for, with respect to the parallel spoken language corpora B, searching a source-target language dictionary and a target-source language dictionary for the words in the parallel spoken language corpora B to obtain a dictionary-based word alignment set F, in which each alignment item is an entry of the source- target language dictionary and also is an entry of the target-source language dictionary; and union getting unit 725 for obtaining the union of the corpus-based statistics word alignment set E and the dictionary-based word alignment set F as the statistics method and dictionaries-based high precision word alignment set G.

The chunk aligning unit 73 is configured to align chunks in the preprocessed parallel spoken language corpora B in the spoken language corpus repository by using the statistics method and dictionaries-based high precision word alignment set G obtained by the high precision word alignment set getting unit 72, to obtain a chunk alignment set and store it into the chunk alignment set storage unit 76.

As shown in FIG. 7, the chunk aligning unit 73 further comprises: chunk analyzing unit 731 for performing chunk analysis on the parallel spoken language corpora B to identify chunks therein, thus forming chucked parallel spoken language corpora H; source language head word extracting unit 732 for extracting head words of the identified source language chucks from the chucked parallel spoken language corpora H, to form a head word set I of source language chucks; target language head word extracting unit 733 for extracting head words of the identified target language chucks from the chucked parallel spoken language corpora H, to form a head word set J of target language chucks; head word aligning unit 734 for aligning the head word set I of source language chucks and the head word set J of target language chucks by using the statistics method and dictionaries-based high precision word alignment set G, to obtain a head word alignment set K, in which each alignment item is an alignment item in the statistics method and dictionaries-based high precision word alignment set G; and chuck alignment set getting unit 735 for, according to aligned head word couples in the head word alignment set K, aligning the chucks containing the head words in the parallel spoken language corpora H to obtain a chuck alignment set L.

The word-in-chunk aligning unit 74 is configured to obtain the union S of the above statistics word alignment set C from source to target obtained by the source-target language statistics word aligning unit 721, the statistics word alignment set D from target to source obtained by the target-source language statistics word aligning unit 722 and the dictionary- based word alignment set F obtained by the dictionary- based word aligning unit 724, and align words in the aligned chucks of the chuck alignment set L by using the union S to obtain a chuck alignment-based word alignment set M, in which each alignment item is an alignment item in theunion S.

The apparatus 70 for aligning parallel spoken language corpora of the present embodiment may further comprise word alignment correcting unit 75 for correcting word alignment errors due to disfluencies of spoken language in the chuck alignment-based word alignment set M to obtain final word alignment set N and store it into the word alignment set storage unit 77.

As shown in FIG. 7, the word alignment correcting unit 75 may further comprise: repetition fragment restoring unit 751 for restoring the repetition fragments deleted by the preprocessing unit 71 in the chuck alignment-based word alignment set M, in order that the alignment items corresponding to the fragments appeared repetitively more than once in the parallel spoken language corpora are the same in the word alignment set M; tag part handling unit 752 for, according to the special tag assigned to hesitating words by the preprocessing unit 71, deleting non-null word alignment items corresponding to the tag from the chuck alignment-based word alignment set M, in order that the word alignment set M exclude word alignment items corresponding to the hesitating words; and ellipsis part handling unit 753 for deleting word alignment items corresponding to the ellipsis fragments in the parallel spoken language corpora B from the chuck alignment-based word alignment set M.

The above is the detailed description of the apparatus for aligning parallel spoken language corpora of the present embodiment. The apparatus for aligning parallel spoken language corpora of the present embodiment can decrease the ambiguities of spoken language word alignment by using the integrality of chunks, and clean alignment errors due to characteristics of spoken language by special processing with respect to the disfluencies such as ellipsis, repetition, hesitation and etc. in spoken language corpora, thus alignment of spoken language can be achieved effectively to obtain highly refine chunk alignment set and word alignment set.

In addition, it should be noted that, the chunk alignment set and word alignment set obtained by the apparatus for aligning parallel spoken language corpora of the embodiment can be applied not only in the speech-to-speech machine translation system, but also in many other language processing fields such as text machine translation, information retrieval and so on.

The apparatus 70 for aligning parallel spoken language corpora of the present embodiment and its components can be implemented with specifically designed circuits or chips or be implemented by a computer (processor) executing corresponding programs. Moreover, the apparatus 70 for aligning parallel spoken language corpora of the present embodiment can operationally implement the method for aligning parallel spoken language corpora described above in conjunction with FIGS. 1-5.

The speech-to-speech machine translation system of the present invention employing the apparatus for aligning parallel spoken language corpora of the embodiment described above in conjunction with FIG. 7 will be described below in conjunction with the drawings.

FIG. 8 is a block diagram of a speech-to-speech machine translation system according to an embodiment of the present invention. As shown in FIG. 8, the speech-to-speech machine translation system 80 of the present embodiment comprises the apparatus for aligning parallel spoken language corpora 70 of the embodiment described in conjunction with FIG. 7, speech-to-speech translation module 81 and spoken language corpus repository storage unit 82.

Specifically, in the speech-to-speech machine translation system 80 of the present embodiment, by using the apparatus for aligning parallel spoken language corpora 70, a chunk alignment set L and a word alignment set N are obtained from parallel spoken language corpora in the pre-constructed spoken language corpus repository in the spoken language corpus repository storage unit 82.

Then the speech-to-speech translation module 81 performs speech-to-speech translation on spoken language sentences to be translated, which are inputted by a user, by using the chunk alignment set L and the word alignment set N, to obtain target language speech corresponding to the input spoken language sentences.

The above is the detailed description of the speech-to-speech machine translation system of the present embodiment. The speech-to-speech machine translation system of the present embodiment can obtain highly accurate speech-to-speech translation result by applying the chunk alignment set and the word alignment set obtained by the apparatus for aligning parallel spoken language corpora 70 from the parallel spoken language corpora in the pre-constructed spoken language corpus repository, to the speech-to-speech machine translation.

While the method and apparatus for aligning parallel spoken language corpora as well as the speech-to-speech machine translation method and system employing such method and apparatus for aligning parallel spoken language corpora respectively of the present invention have been described in detail with some exemplary embodiments, these embodiments are not exhaustive, and those skilled in the art may make various variations and modifications within the spirit and scope of the present invention. Therefore, the present invention is not limited to these embodiments; rather, the scope of the present invention is solely defined by the appended claims.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for aligning parallel spoken language corpora, comprising:
obtaining a statistics method and dictionaries- based word alignment set from the parallel spoken language corpora;
aligning chunks of the parallel spoken language corpora by using the statistics method and dictionaries-based word alignment set, to obtain a chunk alignment set; and
aligning words in aligned chunks of the parallel spoken language corpora to obtain a chunk alignment-based word alignment set.

2. The method for aligning parallel spoken language corpora according to claim 1, further comprising the following steps prior to the step of obtaining a statistics method and dictionaries-based word alignment set from the parallel spoken language corpora:
deleting repetition fragments from the parallel spoken language corpora; and
assigning a special tag to hesitating words in the parallel spoken language corpora.

3. The method for aligning parallel spoken language corpora according to claim 1, wherein the step of obtaining a statistics method and dictionaries-based word alignment set from the parallel spoken language corpora further comprises:
obtaining a statistics word alignment set from source to target language based on the parallel spoken language corpora;
obtaining a statistics word alignment set from target to source language based on the parallel spoken language corpora;
obtaining the intersection of the statistics word alignment set from source to target language and the statistics word alignment set from target to source language;
with respect to the parallel spoken language corpora, searching a source-target language dictionary and a target-source language dictionary for words in the parallel spoken language corpora, to obtain a dictionary-based word alignment set; and
obtaining the union of the intersection of the statistics word alignment set from source to target language and the statistics word alignment set from target to source language with the dictionary-based word alignment set, as the statistics method and dictionaries-based word alignment set.

4. The method for aligning parallel spoken language corpora according to claim 1, further comprising the following step prior to the step of aligning chunks of the parallel spoken language corpora by using the statistics method and dictionaries-based word alignment set:
performing chunk analysis on the parallel spoken language corpora to identify chunks therein.

5. The method for aligning parallel spoken language corpora according to claim 1, wherein the step of aligning chunks of the parallel spoken language corpora by using the statistics method and dictionaries-based word alignment set further comprises:
extracting a head word set of source language chunks from chucked parallel spoken language corpora of the parallel spoken language corpora;
extracting a head word set of target language chunks from the chucked parallel spoken language corpora;
aligning the head word set of source language chunks and the head word set of target language chunks by using the statistics method and dictionaries-based word alignment set to obtain a head word alignment set; and
aligning chunks in the chucked parallel spoken language corpora based on the head word alignment set to obtain a chunk alignment set.

6. The method for aligning parallel spoken language corpora according to claim 3, wherein the step of aligning words in aligned chunks of the parallel spoken language corpora to obtain a chunk alignment-based word alignment set further comprises:
obtaining the union of the statistics word alignment set from source to target, the statistics word alignment set from target to source and the dictionary-based word alignment set; and
aligning words in aligned chunks of the parallel spoken language corpora by using the union.

7. The method for aligning parallel spoken language corpora according to claim 2, wherein the step of aligning words in aligned chunks of the parallel spoken language corpora to obtain a chunk alignment-based word alignment set further comprises:
restoring the repetition fragments deleted in the step of deleting repetition fragments into the chunk alignment-based word alignment set;
according to the special tag assigned to the hesitating words in the step of assigning a special tag, deleting non-null word alignment items corresponding to the tag from the chunk alignment-based word alignment set; and
deleting word alignment items corresponding to ellipsis fragments of the parallel spoken language corpora from the chunk alignment-based word alignment set.

8. A speech-to-speech machine translation method, which performs speech-to-speech machine translation based on a spoken language corpus repository containing parallel spoken language corpora, the method comprises:
obtaining a chunk alignment set and a word alignment set from the parallel spoken language corpora in the spoken language corpus repository by using the method for aligning parallel spoken language corpora according to claim 1; and
performing source-to-target language speech-to-speech machine translation on input spoken language sentences to be translated by using the chunk alignment set and the word alignment set.

9. An apparatus for aligning parallel spoken language corpora, comprising:
a statistics method and dictionaries-based word alignment set getting unit for obtaining a statistics method and dictionaries-based word alignment set from the parallel spoken language corpora;
a chunk aligning unit for aligning chunks of the parallel spoken language corpora by using the statistics method and dictionaries-based word alignment set, to obtain a chunk alignment set; and
a word-in-chunk aligning unit for aligning words in aligned chunks of the parallel spoken language corpora to obtain a chunk alignment-based word alignment set.

10. The apparatus for aligning parallel spoken language corpora according to claim 9, further comprising:
a preprocessing unit for preprocessing the parallel spoken language corpora with respect to characteristics of spoken language;
the preprocessing unit further comprises:
a repetition fragment deleting unit for deleting repetition fragments from the parallel spoken language corpora; and
a special tag assigning unit for assigning a special tag to hesitating words in the parallel spoken language corpora.

11. The apparatus for aligning parallel spoken language corpora according to claim 9, wherein the statistics method and dictionaries-based word alignment set getting unit further comprises:
a source-target language statistics word aligning unit for obtaining a statistics word alignment set from source to target language based on the parallel spoken language corpora; and
a target-source language statistics word aligning unit for obtaining a statistics word alignment set from target to source language based on the parallel spoken language corpora; and
an intersection getting unit for obtaining the intersection of the statistics word alignment set from source to target language and the statistics word alignment set from target to source language;
a dictionary-based word aligning unit for, with respect to the parallel spoken language corpora, searching a source-target language dictionary and a target-source language dictionary for words in the parallel spoken language corpora, to obtain a dictionary-based word alignment set; and
an union getting unit for obtaining the union of the intersection of the statistics word alignment set from source to target language and the statistics word alignment set from target to source language with the dictionary-based word alignment set, as the statistics method and dictionaries-based word alignment set.

12. The apparatus for aligning parallel spoken language corpora according to claim 9, wherein the chunk aligning unit further comprises:
a chunk analyzing unit for performing chunk analysis on the parallel spoken language corpora to identify chunks therein.

13. The apparatus for aligning parallel spoken language corpora according to claim 9, wherein the chunk aligning unit further comprises:
a source language head word extracting unit for extracting a head word set of source language chunks from chucked parallel spoken language corpora of the parallel spoken language corpora;
a target language head word extracting unit for extracting a head word set of target language chunks from the chucked parallel spoken language corpora;
a head word aligning unit for aligning the head word set of source language chunks and the head word set of target language chunks by using the statistics method and dictionaries-based word alignment set to obtain a head word alignment set; and
a chunk alignment set getting unit for aligning chunks in the chucked parallel spoken language corpora based on the head word alignment set to obtain a chunk alignment set.

14. The apparatus for aligning parallel spoken language corpora according to claim 11, wherein the word-in-chunk aligning unit obtains the union of the statistics word alignment set from source to target obtained by the source-target language statistics word aligning unit, the statistics word alignment set from target to source obtained by the target-source language statistics word aligning unit and the dictionary-based word alignment set obtained by the dictionary-based word aligning unit, andaligns words in aligned chunks of the parallel spoken language corpora by using the union.

15. The apparatus for aligning parallel spoken language corpora according to claim 10, further comprising:
a word alignment correcting unit for correcting word alignment errors due to disfluencies of spoken language in the chunk alignment-based word alignment set obtained by the word-in-chunk aligning unit;
the word alignment correcting unit further comprises:
a repetition fragment restoring unit for restoring the repetition fragments deleted by the repetition fragment deleting unit into the chunk alignment-based word alignment set;
a tag part handling unit for, according to the special tag assigned to the hesitating words by the special tag assigning unit, deleting non-null word alignment items corresponding to the tag from the chunk alignment-based word alignment set; and
an ellipsis part handling unit for deleting word alignment items corresponding to ellipsis fragments of the parallel spoken language corpora from the chunk alignment-based word alignment set.

16. A speech-to-speech machine translation system, which performs speech-to-speech translation based on a spoken language corpus repository containing parallel spoken language corpora, the system comprises:
the apparatus for aligning parallel spoken language corpora according to claim 9 for obtaining a chunk alignment set and a word alignment set from the parallel spoken language corpora in the spoken language corpus repository; and
a speech-to-speech translation module for performing source-to-target language speech-to-speech translation on input spoken language sentences to be translated by using the chunk alignment set and the word alignment set.
